(19) United States
(12) Patent Application Publication
(10) Pub. No.: US 2016/0014108 A1
(43) Pub. Date: Jan. 14, 2016

(54) PORTABLE HOME DEVICE MANAGING SYSTEMS AND DEVICES THEREOF

(71) Applicant: Shuttle Inc., Taipei (TW)

(72) Inventors: Nien-Tsu Chen, New Taipei (TW); Chun-Lun Kuo, Kaoshiung (TW); Pang-Hao Wang, New Taipei (TW)

(21) Appl. No.: 14/794,846

(22) Filed: Jul. 9, 2015

Related U.S. Application Data
(60) Provisional application No. 62/023,964, filed on Jul. 14, 2014.

(51) Int. Cl. H04L 29/06; H04L 29/08

(52) U.S. Cl. CPC H04L 63/08; H04L 67/10; H04L 67/025; H04L 63/10

(57) ABSTRACT

The present invention discloses a portable home device managing system. The system may include a private cloud having a first home device and a wireless access point connected thereto, wherein the first home device is equipped with a first communication element capable of communicating with the wireless access point via a first communication protocol, and wherein the wireless access point is connected to the Internet; and a mobile device authorized to access the private cloud through the Internet, wherein the mobile device transmits an instruction to said first home device as a server to a client so as to control the first home device via a software APP installed on the mobile device.

### CROSS-REFERENCE TO RELATED APPLICATIONS

This application is related to and claims priority to U.S. provisional patent application, U.S. Provisional Application No. 62/023,964 filed on Jul. 14, 2014, by the applicants Nien Tsu Chen et al., entitled “Portable servers for managing home appliances and other devices, applications thereof, architectures thereof and methods.”

### FIELD OF THE INVENTION

The present invention relates to portable home device managing systems and devices thereof; more particularly, the present invention relates to portable home device managing systems that utilize mobile devices as servers to remotely control a plurality of home devices.

### BACKGROUND OF THE INVENTION

Traditionally, a Windows®-based server is required to manage a plurality of home appliances in a home automation environment. One drawback of using a Windows®-based server is that it requires a relatively large amount of processing power for the managing tasks. A Windows®-based server also takes up a lot of physical space. Additionally, more and more people rely on their cell phone to manage their daily tasks.

Therefore, what is needed is a portable home device managing system that utilizes a mobile device to act as a server to remotely manage the home appliances. More particularly, what is needed is a portable home device managing system that utilizes a mobile device to act as a server such that a user can remotely manage the home appliances via a software APP installed on the mobile device.

### SUMMARY OF THE INVENTION

In light of the drawbacks of the above prior arts, one object of the present invention is to provide a portable home device managing system utilizing a mobile device to remotely manage a plurality of home devices via a software APP installed on the mobile device.

In accordance with the present invention, the portable home device managing system may include a private cloud having a first home device and a wireless access point connected thereto, wherein the first home device is equipped with a first communication element capable of communicating with the wireless access point via a first communication protocol, and wherein the wireless access point is connected to the Internet; and a mobile device authorized to access the private cloud through the Internet, wherein the mobile device transmits an instraction to said first home device as a server to a client so as to remotely control the first home device via a software APP installed on the mobile device.

Another object of the present invention is to provide a mobile device that acts as a server in a home automation environment by utilizing a software APP installed thereon to remotely operate a plurality of home devices in the home automation environment.

In accordance with the present invention, the mobile device acts as a server to control a home automation environment via an Internet connection, wherein the home automation environment includes a first home device and a wireless access point connected thereto, and wherein the first home device is equipped with a first communication element capable of communicating with the wireless access point via a first communication protocol, and wherein the wireless access point is connected to the Internet connection. The mobile device of the present invention may include a computer readable medium storing a software APP to manage the first home device; a display element displaying an icon associated with the software APP to allow a user to generate instructions associated with managing the first home device; an ARMS-based processor electrically coupled to the display element and the computer readable medium to process the instructions; a transceiver electrically coupled to the computer readable medium to transmit the instructions to the first home device, wherein the mobile device transmits the instructions to the first home device as a server to a client so as to remotely control the first home device via the software APP.

Certain embodiments of the invention have other aspects in addition to or in place of those mentioned above. The aspects will become apparent to those skilled in the art from reading of the following detailed description when taken with reference to the accompanying drawings.

### BRIEF DESCRIPTION OF DRAWINGS

FIG. 1 is a schematic view of a portable home device managing system in accordance with one embodiment of the present invention; and

FIG. 2 is a schematic view of a mobile device acting as a server in a home automation environment in accordance with one embodiment of the present invention.

### DETAILED DESCRIPTION OF THE INVENTION

The following embodiments are described in sufficient detail to enable those skilled in the art to make and use the invention. It is to be understood that other embodiments would be evident based on the present disclosure, and that changes may be made without departing from the scope of the present invention.

The present invention provides a portable home device managing system. In particular, the present invention provides a portable home device managing system utilizing a mobile device to act as a server to remotely manage a plurality of home devices in a home automation environment. In one embodiment of the present invention, the mobile device may be installed with a software APP such that a user may remotely control the plurality of home devices from the mobile device through the software APP as if the user is operating the home devices at home. For example, the user may remotely switch a home device on and off, and/or adjust a parameter of a home device from the mobile device through the software APP.

In another embodiment of the present invention, the user may use a web browser installed on the mobile device to remotely control the plurality of home devices as if the user is operating the home devices at home. For example, the user may remotely switch a home device on and off, and/or adjust a parameter of a home device from the mobile device through the web browser. As a result, the plurality of home devices can be easily controlled by the user through the use of the mobile device.

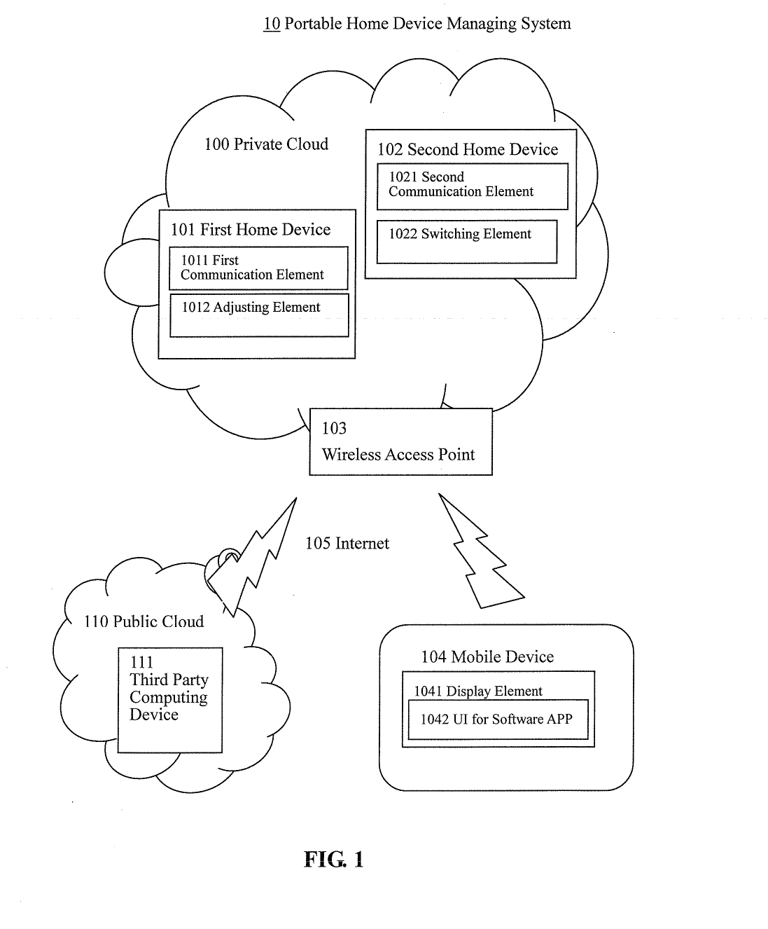

Refer to FIG. 1, which illustrates a schematic view of a portable home device managing system in accordance with one embodiment of the present invention. As shown in FIG. 1, in one embodiment of the present invention, the portable home device managing system 10 may include a private cloud 100. In one embodiment of the present invention, a plurality of home devices, such as a first home device 101 and a second home device 102, may be implemented within the private cloud 100 so as to increase security of these home devices. In one embodiment of the present invention, the private cloud 100 may further include a wireless access point 103 connected thereto to allow the plurality of home devices, such as the first home device 101 and the second home device 102, to be accessed by a device outside of the private cloud 100, such as a mobile device 104.

In accordance with the present invention, the first home device 101 may include a first communication element 1011 so as to communicate with the wireless access point 103 via a first communication protocol. In one example, the first home device 101 may be an air conditioner, and the first communication element 1011 may be a sensor installed in the air conditioner. The sensor of the present invention may be capable of communicating with the wireless access point 103 in the first communication protocol, such as a z-wave protocol.

In accordance with the present invention, the first home device 101 may include an adjusting element 1012 to allow a user to adjust a parameter of the first home device 101. In one example, the first home device 101 of the present invention may be an air conditioner, and the adjusting element 1012 may be a temperature setting controller installed in the air conditioner. As such, the user may adjust the temperature setting of the air conditioner through the adjusting element 1012.

In accordance with the present invention, the second home device 102 may include a second communication element 1021 so as to communicate with the wireless access point 103 via a second communication protocol. In one example, the second home device 102 may be a lighting device, and the second communication element 1021 may be a transceiver installed in the lighting device. The transceiver of the present invention may be capable of communicating with the wireless access point 103 in the second communication protocol, such as an IR remote control protocol. In another example, the second home device 102 may be a security camera, and the second communication element 1021 may be a transceiver installed in the security camera. The transceiver of the present invention may be capable of communicating with the wireless access point 103 in the second communication protocol, such as a WiFi protocol.

In accordance with the present invention, the second home device 102 may include a switching element 1022 to allow a user to turn on and/or off a switch of the second home device 102. In one example, the second home device 102 of the present invention may be a lighting device, and the switching element 1022 may be a switch installed in the air conditioner. As such, the user may switch the lighting device on and off through the switching element 1022. In another example, the second home device 102 of the present invention may be a security camera, and the switching element 1022 may be a switch to the camera lens. As such, the user may activate the security camera by turning the camera lens on and de-activate the security camera by turning the camera lens off. However, it should be noted that the present invention is not limited to the above-mentioned home devices, communication elements and communication protocols. Any other home devices, communication elements, and communication protocols may also be implemented in accordance with the present invention. For example, the home devices of the present invention may also be implemented as electronic door locks, smart televisions, smoke detectors, visual doorbells, door sensors, window sensors, temperature sensors, motion detectors, roller shutter controllers, etc.

In accordance with the present invention, the wireless access point 103 may be a gateway for the plurality of home devices, such as the first home device 101 and the second home device 102, within the private cloud 100 to be accessed by a device outside of the private cloud 100. The wireless access point 103 may be connected to the Internet 105 such that a device outside of the private cloud 100 may access the plurality of home devices, such as the first home device 101 and the second home device 102, through the Internet 105.

In accordance with the present invention, the wireless access point 103 may communicate with the plurality of home devices, such as the first home device 101 and the second home device 102, in different communication protocols, such as the z-way protocol, IR remote control protocol, or WiFi protocol, as mentioned above. However, it should be noted that the communication protocols the wireless access point 103 of the present invention may be able to communicate in may not be limited to the above-mentioned communication protocols. Any other communication protocols those ordinarily skilled in the art may contemplate are also within the scope of the present invention.

In accordance with the present invention, the mobile device 104 may be a device outside of the private cloud 100 authorized to access the plurality of home devices, such as the first home device 101 and the second home device 102, through the Internet 105. In one embodiment of the present invention, the mobile device 104 may be a cell phone installed with a software APP to allow a user to remotely manage the plurality of home devices, such as the first home device 101 and the second home device 102, as if the user is operating the plurality of home devices, such as the first home device 101 and the second home device 102, at home. However, it should be noted that any other mobile devices, including but not limited to tablets, electronic readers, notebooks, Android® phones, iPhone®, iPad®, etc., those ordinarily skilled in the art may contemplate are also within the scope of the present invention.

The mobile device 104 of the present invention may include a display element 1041 to display the software APP. The software APP of the present invention may include a user interface 1042 to be displayed on the mobile device 104, such as a cell phone, to allow the user to control a parameter of the plurality of home devices, such as the first home device 101 and the second home device 102. In other words, the mobile device 104 of the present invention may act as a server in relation to the plurality of home devices, such as the first home device 101 and the second home device 102, so that the control of the plurality of home devices is centralized at the mobile device 104.

In a preferred embodiment of the present invention, the mobile device 104 of the present invention may transmit an instruction generated by the software APP to the plurality of home devices, such as the first home device 101 and the second home device 102, as a server to clients, as such the user can remotely control the plurality of home devices, such as the first home device 101 and the second home device 102 via the use of the software APP from the mobile device 104.

In one embodiment of the present invention, the user may use the software APP installed on the mobile device 104, such as a cell phone, to control the first home device 101, such as the air conditioner. In one example, the user may open the software APP installed on the mobile device 104, such as a cell phone, and adjust a parameter of the first home device 101, such as the temperature setting of the air conditioner before he or she gets home by, for example, pressing a button associated with the adjusting element 1012. In another embodiment of the present invention, the user may open the software APP installed on the mobile device 104, such as a cell phone, and turn the switch of the second home device 102, such as the lighting device, on or off remotely by, for example, pressing a button associated with the switching element 1022. In yet another embodiment of the present invention, the user may open the software APP installed on the mobile device 104, such as a cell phone, and video stream what the second home device 102, such as the security camera, is monitoring from a remote place by, for example, pressing a button associated with the camera lens.

In another embodiment of the present invention, the user may be authorized to use a web browser installed on the mobile device 104, such as a cell phone, to control the plurality of home devices, such as the first home device 101 and the second home device 102. In one example, the user may be authorized to open the web browser installed on the mobile device 104, such as a cell phone, and adjust a parameter of the first home device 101, such as the temperature setting of the air conditioner before he or she gets home by, for example, pressing CL button associated with the adjusting element 1012. In another embodiment of the present invention, the user may open the web browser installed on the mobile device 104, such as a cell phone, and turn the switch of the second home device 102, such as the lighting device, on or off remotely by, for example, pressing a button associated with the switching element 1022. In yet another embodiment of the present invention, the user may open the web browser installed on the mobile device 104, such as a cell phone, and video stream what the second home device 102, such as the security camera, is monitoring from a remote place by, for example, pressing on a button associated with the camera lens.

In accordance with the present invention, the portable home device managing system 10 may include a public cloud 110. In one embodiment of the present invention, a third-party computing device 111, such as a laptop, may be part of the public cloud 110. However, it should be noted that the third-party computing device 111 of the present invention is not limited to a laptop device. Any other computing devices, including but not limited to a personal computer, an all-in-one computer, a cell phone, a tablet, an electronic reader, etc., are also within the scope of the present invention,

The third-party computing device 111 of the present invention, such as a laptop, may be authorized to access the plurality of home devices, such as the first home device 101 and the second home device 102, through the Internet 105. As such, the third-party computing device 111 of the present invention, such as a laptop, may retrieve data from the plurality of home devices, such as the first home device 101 and the second home device 102, for data mining, data analysis, or other purposes.

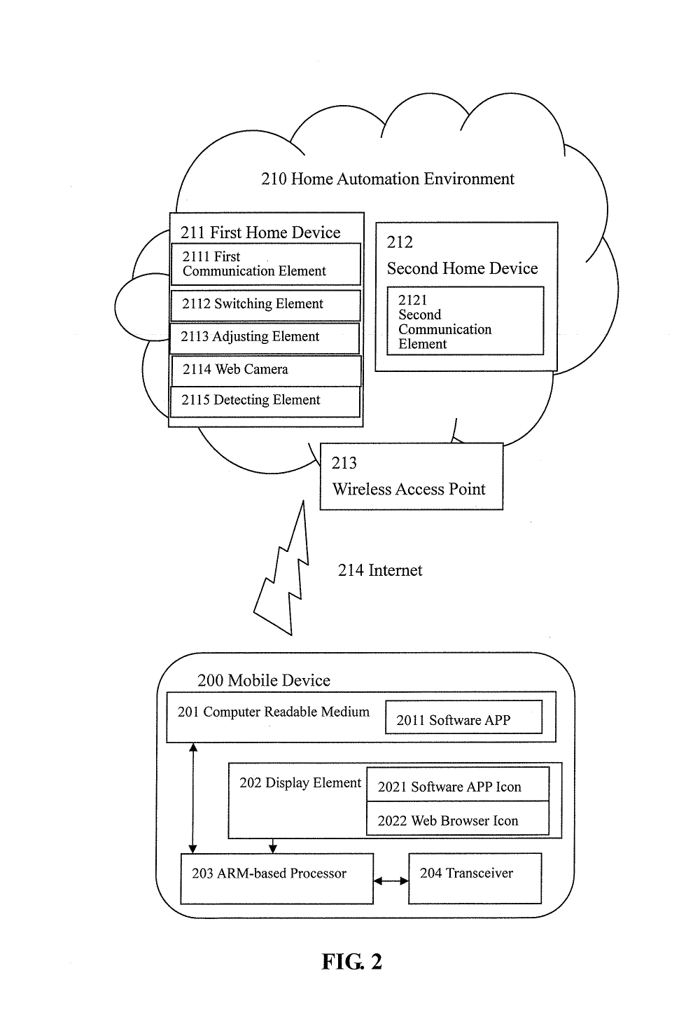

Refer now to FIG. 2, which illustrates a schematic view of a mobile device acting as a server in a home automation environment in accordance with one embodiment of the present invention. As shown in FIG. 2, the home automation environment 210 may include a first home device 211, a second home device 212, and a wireless access point 213. As discussed above, the first home device 211 of the present invention may include a first communication element 2111 so as to communicate with the wireless access point 213 via a first communication protocol. In one example, the first home device 211 may be an air conditioner, and the first communication element 2111 may be a sensor installed in the air conditioner. The sensor of the present invention may be capable of communicating with the wireless access point 213 in the first communication protocol, such as a z-wave protocol.

In accordance with the present invention, the first home device 211 may include a switching element 2112 to allow a user to turn on a switch of the first home device 211. In one example, the first home device 211 of the present invention may be a lighting device, and the switching element 2112 may be a switch installed in the air conditioner. As such, the user may switch the lighting device on and off through the switching element 2112.

In accordance with the present invention, the first home device 211 may include an adjusting element 2113 to allow a user to adjust a parameter of the first home device 211. In one example, the first home device 211 of the present invention may be an air conditioner, and the adjusting element 2113 may be a temperature setting controller installed in the air conditioner. As such, the user may adjust the temperature setting of the air conditioner through the adjusting element 2113.

In accordance with the present invention, the first home device 211 may include a web camera 2114. As such, the user may monitor the home environment 210 by video streaming or recording the place through the web camera 2114.

In accordance with the present invention, the first home device 211 may include a detecting element 2115. The detecting element 2115 of the present invention may allow a user to detect a condition of the home automation environment 210. In one example, the detecting element 2115 of the present invention may be implemented as a motion detector. As such, the user may be notified when a motion is detected in the home automation environment 210.

In accordance with the present invention, the second home device 212 may include a second communication element 2121 so as to communicate with the wireless access point 213 via a second communication protocol. In one example, the second home device 212 may be a lighting device, and the second communication element 2121 may be a transceiver installed in the lighting device. The transceiver of the present invention may be capable of communicating with the wireless access point 213 in the second communication protocol, such as an IR remote control protocol. In another example, the second home device 212 may be a security camera, and the second communication element 2121 may be a transceiver installed in the security camera. The transceiver of the present invention may be capable of communicating with the wireless access point 213 in the second communication protocol, such as a WiFi protocol. However, it should be noted that the present invention is not limited to the above-mentioned home devices, communication elements and communication protocols. Any other home devices, communication elements, and communication protocols may also be implemented in accordance with the present invention. For example, the home devices of the present invention may also be implemented as electronic door locks, smart televisions, smoke detectors, usual doorbells, door sensors, window sensors, temperature sensors, motion detectors, roller shutter controllers, etc., as mentioned above.

In accordance with the present invention, the wireless access point 213 may be a gateway for the plurality of home devices, such as the first home device 211 and the second home device 212, within the home automation environment 210 to be accessed by a device outside of the environment 210. The wireless access point 213 may be connected to the Internet 214 such that a device outside of the home automation environment 210 may access the plurality of home devices, such as the first home device 211 and the second home device 212, through the Internet 214.

In accordance with the present invention, the wireless access point 213 may communicate with the plurality of home devices, such as the first home device 211 and the second home device 212, in different communication protocols, such as the z-way protocol, IR remote control protocol, or WiFi protocol, as mentioned above. However, it should be noted that the communication protocols that the wireless access point 213 of the present invention may communicate in may not be limited to the above-mentioned communication protocols. Any other communication protocols those ordinarily skilled in the art may contemplate are also within the scope of the present invention.

In accordance with the present invention, the mobile device 200 may be a device outside of the home automation environment 210 authorized to access the plurality of home devices, such as the first home device 211 and the second home device 212, through the Internet 214. In one embodiment of the present invention, the mobile device 200 may be implemented as a cell phone installed with a software APP to allow a user to remotely manage the plurality of home devices, such as the first home device 211 and the second home device 212, as if the user is operating the plurality of home devices, such as the first home device 211 and the second home device 212, at home. However, it should be noted that any other mobile devices, including but not limited to tablets, electronic readers, notebooks, Android® phones, iPhone®, iPad®, etc., those ordinarily skilled in the art may contemplate are also within the scope of the present invention.

The mobile device 200 of the present invention, such as a cell phone, may include a transceiver 204 so as to communicate with the plurality of home devices, such as the first home device 211 and the second home device 212, through the Internet 214.

In accordance with the present invention, the mobile device 200, such as a cell phone, may include a computer readable medium 201 storing a software APP 2021 therein so as to allow a user to remotely manage a plurality of home devices, such as the first home device 211 and the second home device 212, in the home automation environment 210 as if the user is operating the plurality of home devices, such as the first home device 211 and the second home device 212, at home. In other words, the mobile device 200 of the present invention, such as a cell phone, may act as a server in relation to the plurality of home devices, such as the first home device 211 and the second home device 212, so that the control of the plurality of home devices is centralized at the mobile device 200, such as a cell phone.

In a preferred embodiment of the present invention, the mobile device 200 of the present invention may transmit an instruction generated by the software APP to the plurality of home devices, such as the first home device 211 and the second home device 212, as a server to clients, as such the user can remotely control the plurality of home devices, such as the first home device 211 and the second home device 212 via the use of the software APP from the mobile device 200.

In one embodiment of the present invention, the computer readable medium 201 may be, for example but not limited to any physically tangible device that operates using magnetic, electronic, electromagnetic, optical, or semiconductor components. In particular, the computer readable medium 201 may be a memory card, a hard disk, a portable computer diskette, a random access memory, a read-only memory (ROM), or any other physically tangible medium that can contain, store, communicate, or transport a program for use by or in connection with the mobile device 200.

In accordance with the present invention, the mobile device 200 may also include a display element 202. The display element 202 of the present invention may display an icon associated with the software APP 2011 so that the user may start using the software APP 2011 by clicking on the icon 2021. In one example, by clicking on the icon 2021 displayed on the display element 202, the user may be able to turn the switch of the first home device 211, such as the lighting device, on or off remotely. In another example, by clicking on the icon 2021 displayed on the display element 202, the user may be able to adjust a parameter of the first home device 211, such as the temperature setting of the air conditioner before he or she gets home. In yet another example, by clicking on the icon 2021 displayed on the display element 202, the user may be able to video stream or record what the first home device 211, such as the security camera, is monitoring from a remote place. In yet another example, by clicking on the icon 2021 displayed on the display element 202, the user may be notified by the software app 2021 when a motion is detected in the home automation environment 210.

In accordance with the present invention, the mobile device 200 may be embedded with an ARM-based processor 203. In one example, the mobile device 200 may be an Android® phone, tablet, or smart book, etc. In another example, the mobile device 200 may be an iPhone® or iPad®. As such, the control of the plurality of home devices, such as the first home device 211 and the second home device 212, in the home automation environment 210 may be handled by a small portable device, such as the mobile device 200, with enough processing power to efficiently process the managing tasks as a server in relation to the home devices.

While the invention has been described in conjunction with exemplary preferred embodiments, it is to be understood that many alternatives, modifications, and variations will be apparent to those skilled in the art in light of the foregoing description. Accordingly, it is intended to embrace all such alternatives, modifications, and variations that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A portable home device managing system, said system comprising:
a private cloud having a first home device and a wireless access point connected thereto, wherein said first home device is equipped with a first communication element capable of communicating with said wireless access point via a first communication protocol, and wherein said wireless access point is connected to the Internet; and
a mobile device authorized to access said private cloud through the Internet, wherein said mobile device transmits an instruction to said first home device as a server to a client so as to remotely control said first home device via a software APP installed on said mobile device.

2. The system of claim 1, further comprising a second home device equipped with a second communication element capable of communicating with said wireless access point via a second communication protocol, wherein said mobile device also transmits an instruction to said second home device as a server to a client so as to control said second home device via said software APP.

3. The system of claim 1, wherein said first communication protocol is z-wave.

4. The system of claim 1, wherein said second communication protocol is IR remote control protocol.

5. The system of claim 1, wherein said mobile device is embedded with an ARM®-based processor.

6. The system of claim 1, wherein said first home device includes an adjusting element to allow a user to adjust a parameter of said first home device via said software APP from said mobile device.

7. The system of claim 2, wherein said second home device includes a switching element to allow a user to turn said switching element on and off via said software APP from said mobile device.

8. The system of claim 1, wherein said mobile device allows an authorized user to control said first home device via a web browser.

9. The system of claim 1, further comprising a public cloud allowing a third-party computing device to retrieve data of said first home device through the Internet.

10. The system of claim 1, wherein said software APP includes a user interface displayed on said mobile device to allow a user to control a parameter of said first home device.

11. The system of claim 10, wherein said mobile device includes a display element to display said user interface.

12. A mobile device acting as a server to control a home automation environment via an Internet connection, wherein said home automation environment includes a first home device and a wireless access point connected thereto, and wherein said first home device is equipped with a first communication element capable of communicating with said wireless access point via a first communication protocol, and wherein said wireless access point is connected to said Internet connection, said mobile device comprising:
a computer readable medium storing a software APP to manage said first home device;
a display element displaying an icon associated with said software APP to allow a user to generate instructions associated with managing said first home device;
an ARM®-based processor electrically coupled to said display element and said computer readable medium to process said instructions;
a transceiver electrically coupled to said computer readable medium to transmit said instructions to said first home device,
wherein said mobile device transmits said instructions to said first home device as a server to a client so as to remotely control said first home device via said software APP.

13. The device of claim 12, wherein said first communication protocol is z-wave.

14. The device of claim 12, wherein said first communication protocol is IR remote control protocol.

15. The device of claim 12, wherein said first home device includes an adjusting element to allow said mobile device to adjust a parameter of said first home device via said software APP.

16. The device of claim 12, wherein said first home device includes a switching element to allow said mobile device to turn said switching element on and off via said software APP.

17. The device of claim 12, wherein said display element displays a web browser to allow an authorized user to operate said first home device via said web browser.

18. The device of claim 12, wherein said home automation environment further includes a second home device, and wherein said second home device is equipped with a second communication element capable of communicating with said wireless access point via a second communication protocol, and wherein said mobile device remotely operates said second home device via said software APP.

19. The device of claim 12, wherein said first home device includes a web camera to allow said mobile device to monitor said home automation environment via said software APP.

20. The device of claim 12, wherein said first home device includes a detecting element to allow said mobile device to detect a condition of said home automation environment via said software APP.
